(19) United States
(12) Patent Application Publication
(10) Pub. No.: US 2009/0032784 A1
(43) Pub. Date: Feb. 5, 2009

(54) Winch strap and method

(76) Inventors: Donald E. Bielat, Commerce Township, MI (US); Brian L. Bielat, Walled Lake, MI (US)

Correspondence Address: LAW OFFICE OF RONALD R KILPONEN, P O BOX 1132, NOVI, MI, 48376, US

(21) Appl. No.: 12/221,357

(22) Filed: Aug. 2, 2008

Related U.S. Application Data
(60) Provisional application No. 60/962,874, filed on Aug. 2, 2007.

(51) Int. Cl. B66D 3/00

(52) U.S. Cl. 254/133 R

(57) ABSTRACT

A detachable winch strap is shown and disclosed. The winch strap is attached to a winch and the bow eye of a water vehicle. The winch strap is detachable at a connector located near the winch. Detaching the connector results in a first strap that remains fixed to the winch and a second strap that remains attached to a bow eye of the water vehicle. The second strap can then be used as a bow line for docking and other functions. When launching and loading a water vehicle from and onto a trailer, it is not necessary to get into the water or onto the trailer or lean over the bow to attach or detach the winch strap hook from the eye on the bow of the vehicle. Applicant's winch strap can be installed in existing winches. A method for launching and loading a trailer with the described winch strap is also disclosed.

### CROSS REFERENCE TO RELATED APPLICATIONS:

This application claims the benefit of Provisional Application for Patent Ser. No. 60/962,874 filed on Aug. 2, 2007.

### FIELD

The present version of these embodiments relate generally to the field of devices used to launch and load a water vehicle on and off of a trailer.

### BACKGROUND

These embodiments relate to a device to aid in the launching and loading of a water vehicle for example a boat, onto and off of a trailer. These embodiments disclose a winch strap that interconnects the winch and water vehicle that is disconnected near the winch as opposed to the bow of the water vehicle.

Many people enjoy water sports such as boating, fishing, water skiing, jet skiing and the like. Many of these people do not have property located on lakes and some of those have property on lakes that do not allow motorized vehicles. These and others who enjoy water sports need to tow their water vehicles to the area that they would like to recreate. This necessitates loading and unloading the water vehicle from some type of trailer.

Typically the trailer has two wheels, frame and a winch with a strap that is attached to the bow of the water vehicle and the winch. There are many types of different trailers and water vehicles, but almost all utilize some type of winch and strap that interconnect the winch and the bow of the water vehicle. The trailer and water vehicle are generally hitched to a car or truck with a trailer hitch.

When the user arrives at the destination, they must then unload the water vehicle. This generally occurs at some type of a public launch where the user must pay to park and/or launch. There may be long lines to unload or load a water vehicle boat and some urgency and speed is usually in order.

Launching involves backing the trailer on which the water vehicle is resting to some water depth so that the trailer and water vehicle are both in the water. The winch is used to unroll the strap that interconnects the winch and bow of the water vehicle so that the water vehicle can float off of the trailer.

The winch strap is then disconnected from the bow of water vehicle and wound back up on the winch. One must get into the water, walk onto the trailer or lean over the bow to unhook the winch strap from the bow of the floating water vehicle before rewinding.

A bow rope is then used to pull the water vehicle from the trailer if necessary and the water vehicle is tied up to the dock for passenger or equipment loading. The trailer is then pulled from the water and parked. The water vehicle can then be moved and used.

At the end of the day, the water vehicle must then be loaded back onto the trailer. Many times at the end of the day there is a back up at the ramp and people are rushing and tired and this too can contribute to accidents. Loading involves backing the trailer into the water such that the water vehicle can be floated onto the trailer as far as possible. There is always a danger that the tow vehicle will back too far and then not be able to drive out of the ramp due to the angle or ramp conditions.

A docking rope on the bow can be used to pull the water vehicle up as far as possible onto the trailer, but many water vehicles are heavy and difficult to manually pull and center onto the trailer with the docking rope. The winch is needed to get the water vehicle onto the trailer fully.

The winch strap is then unwound and the hook on the end of the winch line needs to be attached to the bow of the water vehicle. In order to attach the hook to the bow many times involves wading into the water to reach the bow of the water vehicle, or alternatively walking on the trailer frame or leaning over the bow.

None of these options is particularly safe or recommended. Walking in the water can be hazardous as the boat ramps can be very steep, covered in plant growth or algae which can be slippery. There may be rocks or other obstacles to trip on or step on or the water may be cold for example in the spring or fall.

Walking on the trailer to reach the water vehicle to hook up the winch strap to the bow can also be hazardous. The trailer frames are generally not very wide and with wet feet or boots can become slippery also. The water may be cold and there may be hazards on the ramp below the trailer if a fall occurs. Many people are tired after a day on the water and may not have the strength or coordination needed to safely walk on the trailer frame to attach the winch strap to the bow. Leaning over the bow of a water vehicle is not a preferred method either.

Once the winch strap is attached to the bow, the strap is used to pull the water vehicle completely onto the trailer. The water vehicle can then be tied down and pulled from the water.

Up until this time a great majority of water vehicle launchers used one of these methods to load water vehicles onto the trailer and remove them from the trailer at launches.

Applicant has developed a device that greatly diminishes the hazardous condition involved in attaching the winch strap to the bow of the water vehicle. The winch strap is not detached from the bow, the winch strap is detached from the winch near the winch. This allows the launcher to detach the winch strap from near the winch leaving a short piece of strap affixed to the winch. The longer section of winch strap can then be used as a bow line to tie the vehicle to the dock or to pull the vehicle from the trailer if necessary. This is especially convenient as the launcher does not need to reach or climb on the water vehicle to detach the winch strap from the bow and no additional bow line is necessary. Once the winch strap is detached near the winch the longer strap can be stored attached to the bow on or in the water vehicle.

Applicant's device is particularly beneficial when loading a water vehicle. The trailer is backed down the launch and the long winch strap can then be tossed or handed from the water vehicle to a person who carries and attaches the long winch strap to the short winch strap near the winch. There is no need to get into the water, lean over the bow or climb onto the trailer to attach the winch strap to the eye on the bow of the water vehicle as it is already attached. The water vehicle can then be winched onto the trailer and the trailer and water vehicle removed from the launch ramp.

It is not necessary to walk into the cold water, or step onto the slippery or hazardous boat ramp to attach the winch strap to the bow of the vehicle. It is not necessary to walk on the narrow wet trailer to attach the winch strap to the bow of the vehicle. It is not necessary to lean over the bow to attach the hook to the eye on the bow. Applicant's device is already attached to the bow. Applicant believes that this device could significantly reduce the chances of injury that can occur in loading and unloading a water vehicle to and from a trailer.

For the foregoing reasons, there is a need for a winch strap and method.

### SUMMARY

In view of the foregoing disadvantages inherent in the field of launching and loading water vehicles onto and off of trailers at boat launches there is a need for a novel winch strap and method.

A first objective of the embodiments is to provide a winch strap that disconnects at a location near the winch.

Another objective of the embodiments is to provide a strap attachment that is strong and secure to allow the user to pull the water vehicle onto the trailer.

It is yet another objective of the embodiments to discourage users from walking in the water or on the trailer when loading and unloading water vehicles from a trailer.

It is a still further objective of the embodiments to provide a device that can be retrofit to existing winches, water vehicles and trailers.

These together with other objectives of these embodiments, along with various features of novelty which characterize these embodiments, are pointed out with particularity in the claims annexed hereto and forming a part of this disclosure. For a better understanding of these embodiments, the operating advantages and the specific objectives attained by its uses, reference should be had to the accompanying drawings and descriptive matter in which there is illustrated a preferred embodiment.

### BRIEF DESCRIPTION OF DRAWINGS

FIG. 1 shows a side view of one embodiment of the winch strap in use.

FIG. 2 shows a top view of one embodiment of a winch strap.

FIG. 3 shows a top perspective view of one embodiment of the connector.

FIG. 4 shows a bottom perspective view of one embodiment of the connector.

FIG. 5 shows a bottom perspective view of one embodiment of the connector separated.

FIG. 6 shows another bottom perspective view of one embodiment of the connector separated.

FIG. 7 shows an end view of one embodiment of the connector.

FIG. 8 shows a side view of one embodiment of a partial winch strap and connector attached to a partial representation of a winch.

### DETAILED DESCRIPTION

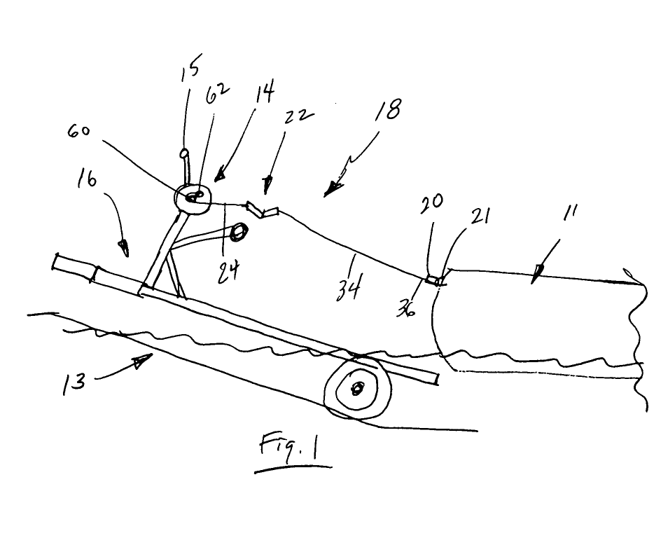

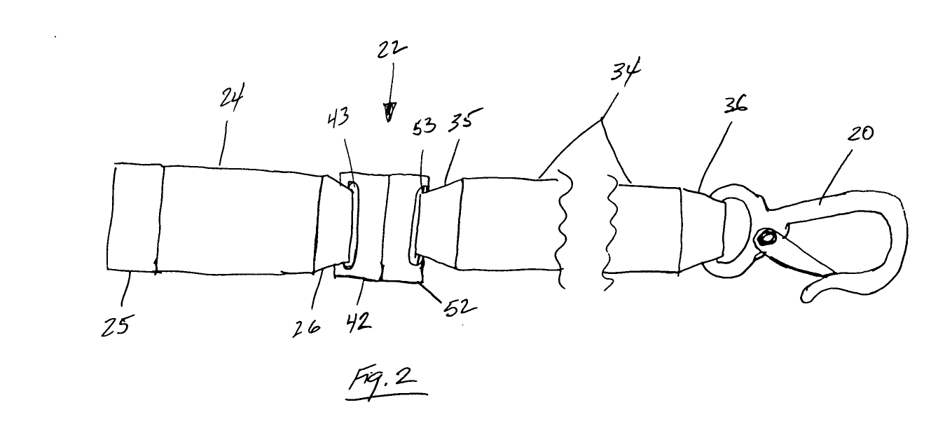

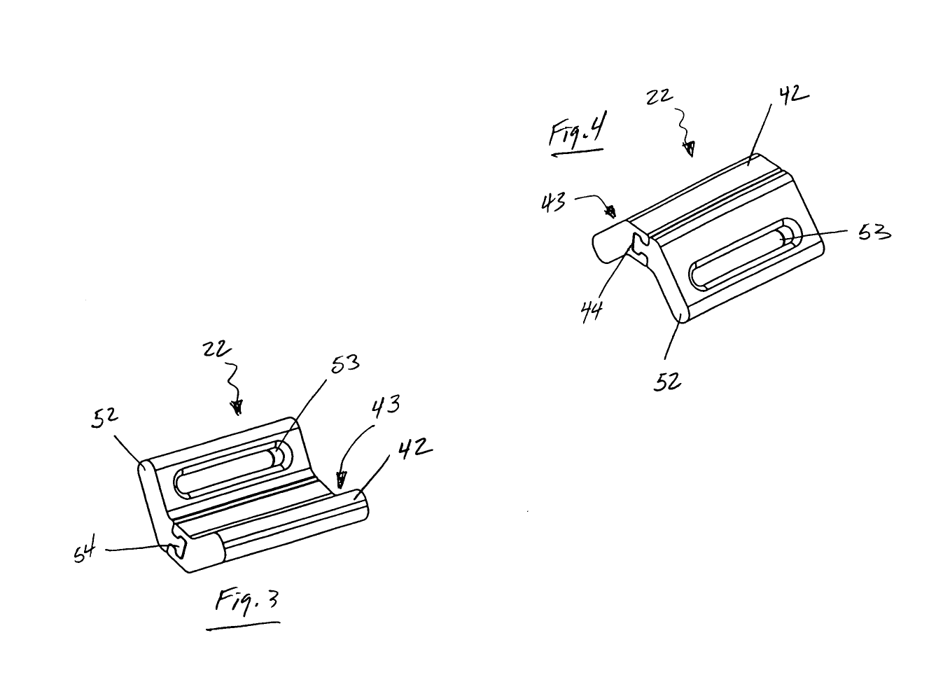

Referring to the drawings in detail wherein like elements are indicated by like numerals, there is shown in FIG. 1 a side view of one embodiment of the winch strap 18 in use. As can be seen, the winch strap 18 is connected at a first end 25, FIG. 2, to an attachment 62 on the winch 14. The winch strap 18 is then looped around the axle 60 of the winch 14 similar to the background art straps and winches. Applicant intends to be able to replace existing background art straps with the winch strap 18 as shown and described herein.

The connector 22 is located relatively close to the winch 14 and first strap 24 is attached to connector 22. A preferred length of first strap 24 is approximately 12 inches. Connector 22 is then attached to second strap 34 which is significantly longer than first strap 24. The length of second strap 34 would obviously vary dependent upon the length of the trailer 16 and the length of the water vehicle 11.

The fourth end 36 of the second strap 34 is attached to a hook 20, FIG. 2. FIG. 2 shows the second end 26 of first strap 24 attached to the female section 42 of connector 22. Male section 52 of connector 22 is attached to the third end 35 of second strap 34. The fourth end 36 of second strap 34 is attached to hook 20. The first and second straps 24, 34 are manufactured from webbing that is known in the art. The first end, second end, third end and fourth end 25, 26, 35, 36 are formed by folding the web over on to itself and sewing the two pieces together to form a loop as is know in the art. The hook 20 has a clasp and is known in the art.

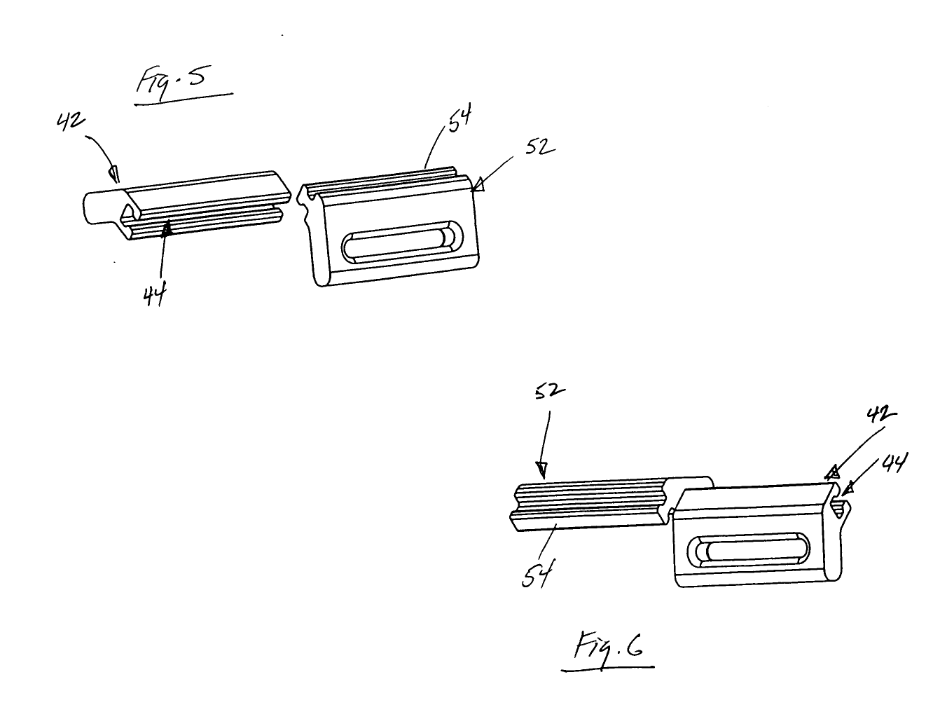

FIG. 3 shows a top perspective view of the connector 22. Connector 22 is formed from the male section 52 and the female section 42. The male section 52 has a slot 53 through which the third end 35 of second strap 34 is looped and sewn. Likewise, female section 42 has a slot 43 through which the second end 26 of first strap 24 is looped and sewn, FIG. 2. The male section 52 has a rail 54 which is removably inserted into a receiver 44 in the female section 42, see FIGS. 5 & 6, to connect male section 52 and female section 42 in forming connector 22.

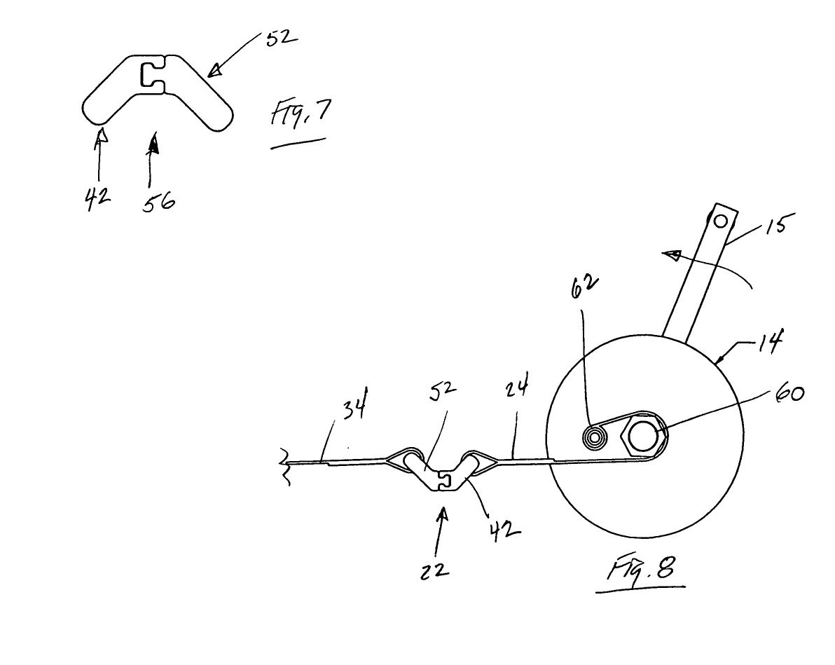

The male and female sections 52, 42 are joined together with the insertion of the rail 54 into the receiver 44 to form an arced portion 56 in the assembled connector 22, see FIG. 7. This arced portion 56 is important in that connector 22 when wound upon the axle 60 of the winch 14 does not take up an excessive amount of space. As can be seen in FIG. 8 the arced portion of connector 22 would contact the first strap 24 as it is wound around axle 60 taking up minimal space when winding winch strap 18. The length of first strap 24 has been sized to allow an optimal amount of first strap 24 to wind on axle 60 before the arced portion 56 of connector 22 contacts the wound first strap 24 and axle 60 to minimize stress on connector 22, first strap 24 and axle 60.

The length of first strap 24 is relatively short so that first strap 24 and connector 22 are wound onto axle 60 before the which strap 18 is loaded. It is anticipated that winch strap 18 first strap 24 and connector 22 will be wound on axle 60 to take out the slack in winch strap 18 before fully loading to pull the water vehicle 11 onto the trailer 16.

To use the winch strap 18 in launching a water vehicle 11 involves backing the trailer 16 into the water on ramp 13 so that the water vehicle 11 is in the water. The winch 14 handle 15 is turned so that the winch strap 18 unwinds from axle 10 and the water vehicle 11 floats off of the trailer 16. The user then detaches the female and male sections 42, 52 and the second strap 34 can then be used to pull the water vehicle 11 from the trailer 16 (if needed) and tie the water vehicle to the dock with second strap 34. Alternatively, the second strap 34 could be held until the gear or passengers were loaded. The second strap 34 remains attached with hook 20 to the eye 21 on the bow of water vehicle 11 and is stored in or on the water vehicle 11 when not in use.

To load the water vehicle 11 onto the trailer 16 involves backing the trailer 16 down the ramp 13. Ideally, the winch 14 will be located over a dry portion of ramp 13 such that the user is not required to enter the water to engage the straps 24, 34 or load the water vehicle 11. The second strap 34 is used to pull the water vehicle 11 onto the trailer 16 as far as possible and then is brought near the winch 14. The male section 52 of second strap 34 is then engaged with the female section 42 of first strap 24. The winch handle 15 is then turned to spool the winch strap 18 onto the axle 60 which pulls the water vehicle 11 onto the trailer 16. It is again noted that there is no need to wade onto the ramp 13 to connect a hook 20 to the eye 21 of the water vehicle 11. It is not necessary to climb on the wet slippery trailer 16 or lean over the bow to engage the hook 20 to the eye 21.

It will now be apparent to those skilled in the art that other embodiments, improvements, details and uses can be made consistent with the letter and spirit of the foregoing disclosure and within the scope of this application, which is limited only by the following claims, construed in accordance with the patent law, including the doctrine of equivalents.

What is claimed is:

1. A device for interconnecting a winch on a trailer and an eye on the bow of a water vehicle, the device comprising:
a first strap having a first end and a second end, the first end connected to the winch;
a female section, the female section having a slot and a receiver, the second end of the first strap attached to the slot in the female section;
a male section having a rail and a slot, the rail removably engaging the receiver of the female section to form a connector;
a second strap having a third end and a fourth end, the third end attached to the slot of the male section, the fourth end retaining a hook, the hook for attachment to the eye of the water vehicle; and
whereby the male and female sections can be detached and the second strap remains affixed to the water vehicle and the first strap remains affixed to the winch.

2. The first strap of claim 1, wherein:
the first strap is shorter than the second strap.

3. The connector of claim 1, further comprising:
the interconnection of the female section and male section forming the connector results in an arc portion.

4. A device for releasably connecting a winch on a trailer and an eye on the bow of a water vehicle, the device comprising:
a first strap having a first end connected to the winch and a second end;
a second strap having a third end and a fourth end attached to a hook;
a connector having a male section removably attached to a female section;
the female section having a slot for attachment of the second end of the first strap and a receiver;
the male section having a slot for attachment of the third end of the second strap and a rail;
the male section and female section attached and detached by insertion of the rail into and out of the receiver; and
whereby the female section and male section can be detached and the second strap remains attached to the eye and the first strap remains attached to the winch.

5. The first strap of claim 4, wherein:
the first strap is shorter than the second strap.

6. The connector of claim 4, further comprising:
the interconnection of the female section and male section forming the connector results in an arc portion.

7. A method for loading and unloading a water vehicle from a trailer using a winch strap connected to a winch and the bow eye of a water vehicle, comprising:
backing the water vehicle and trailer partially into the water;
releasing the winch to un-spool a winch strap;
detaching a male and female section of a connector in the winch strap forming two pieces of winch strap such that the shorter piece is near and remains attached to the winch and the large piece remains attached to the water vehicle;
using the longer piece of winch strap to remove the water vehicle from the trailer;
storing the longer piece of winch strap on or in the boat;
returning the water vehicle to the trailer after use;
attaching the male section and female section of the connector;
winching the water vehicle onto the trailer; and
removing the water vehicle and trailer from the water.
